(19) United States
(12) Patent Application Publication
(10) Pub. No.: US 2011/0148788 A1
(43) Pub. Date: Jun. 23, 2011

(54) TOUCH SCREEN DEVICE WITH COORDINATE CORRECTION MODULE

(75) Inventor: HAI-ZHOU WU, Shenzhen (CN)

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/949,802

(22) Filed: Nov. 19, 2010

(30) Foreign Application Priority Data
Dec. 17, 2009 (CN) 200910311737.4

(51) Int. Cl. G06F 3/041

(52) U.S. Cl. 345/173

(57) ABSTRACT

A touch screen device comprises a coordinate correction module, a controller and a notice module. The controller is initialized when the controller receives an initiation command from a sensor. The notice module sends a control command to the controller, the controller notices the sensor to acquire coordinates of sensing points of the touch device and a pressure sensor to acquire pressure of the sensing points.

### BACKGROUND

1. Technical Field

The present disclosure relates to a touch panel, and more particularly to a touch panel with a coordinate correction system.

2. Description of Related Art

In touch panel technology, a resistive touch panel can be used. However, the coordinates of a finger touch of the resistive touch panel, which is calculated by a controller of the resistive touch panel, is usually not too accurate because human fingers are usually larger than sensing points distributed on the touch panel, and multiple sensing points may be touched by one user touch. Thus, the controller may mistakenly calculate a mismatched coordinate.

### BRIEF DESCRIPTION OF THE DRAWINGS

FIG. 1 is the block diagram of one embodiment of a touch device of the present disclosure.

FIG. 2 is a functional diagram of one embodiment of the coordinate correction module of the present disclosure.

FIG. 3 is a flowchart of one embodiment of a coordinate correction method of the present disclosure.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

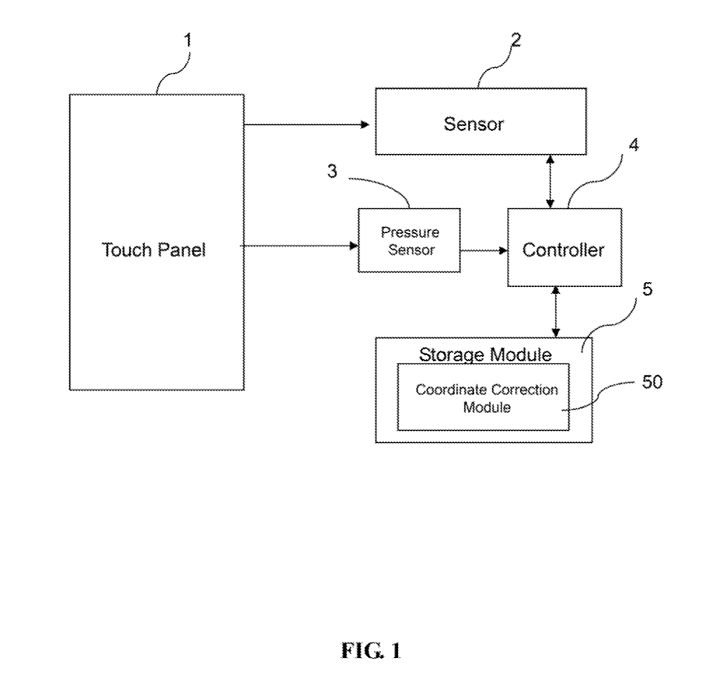

FIG. 1 is the block diagram of one embodiment of a touch device 10 of the present disclosure. The touch device 10 includes a touch panel 1, a sensor 2, a pressure sensor 3, a controller 4 and a storage module 5 comprising a coordinate correction module 50. In one embodiment, the sensors are a touch integrated circuit. The storage module 5 is electrically coupled to the controller 4. The coordinate correction module 50 is disposed in the storage module 50.

The touch panel 1 is generally controlled and coordinated by an operating system, such as UNIX, Linux, Windows, Mac OS, an embedded operating, or any other compatible system. Alternatively, the touch panel 1 may be controlled by a proprietary operating system. Typical operating systems control and schedule computer processes for execution, perform memory management, provide file system, networking, and I/O services, and provide a user interface, such as a graphical user interface (GUI), among other tasks. The touch panel 1 includes sensing points distributed about the touch panel 1, where each sensing point corresponds to a coordinate of the touch panel. Applications are respectively correspond to the sensing points. When user touches specific sensing points using a finger or a stylus (or other objects), corresponding applications are initiated by the controller 4. In one embodiment, a sensing point can correspond to a media player application. When user touches the sensing point, the media player application is initiated/executed.

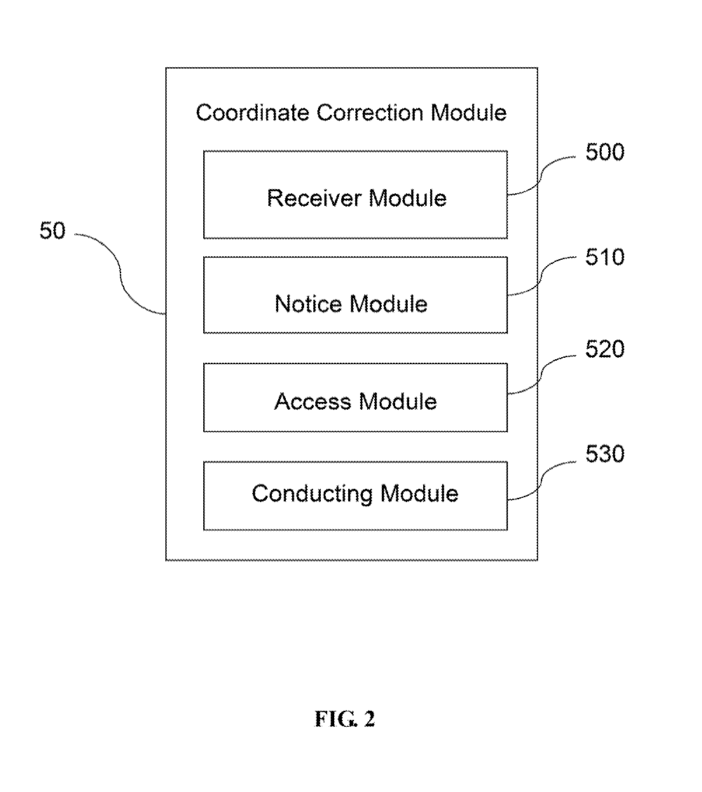

FIG. 2 is a functional diagram of the coordinate correction module 50 of the present disclosure. The coordinate correction module 50 includes a receiver module 500, a notice module 510, an access module 520 and a conducting module 530. The receiver module 500 receives an initiation command from the sensor 2 to initiate the controller 4. In one embodiment, the sensor 2 generates the initiation command when user touches the touch panel 1 using his/her finger or a stylus. The initiation command is sent to the controller 4 to initialize the controller 4 into a working state.

The notice module 510 sends a coordinating command to the controller 4 to control the sensor 2 to acquire the coordinates of the sensing points which are touched by user, and controls the pressure sensor 3 to acquire pressure of the sensing points which are touched by user. In one embodiment, as an example, five sensing points A, B, C, D, E are touched by user. According to different strengths that the user forces on the sensing points A, B, C, D, E, pressures corresponding to each sensing point, detected by the pressure sensor 3, are different.

The access module 520 acquires coordinates of each sensing points from the sensor 2 and acquires pressure of each sensing points from the pressure sensor 3 in sequence at the same time. The access module 520 finds the coordinate of the sensing point with maximum pressure from the coordinates stored in the access module 520, and defines this coordinate as an engaged coordinate. In one embodiment, the access module 520 finds the coordinate of the sensing point with maximum pressure by Bubble Sort algorithm. It should be understood that the Bubble sort algorithm is a simple sorting algorithm that works by repeatedly stepping through the list to be sorted, comparing each pair of adjacent items and swapping them if they are in the wrong order. The pass through the list is repeated until no swaps are needed, which indicates that the list is sorted. For example, the access module 520 compares the pressure of sensing point A with the pressure of sensing point B at first, then remains the one with bigger pressure (sensing point A in this embodiment) to compares with the sensing point C. Secondly, the access module 520 remains the sensing point A if pressure of sensing point A is lager than C. The access module 520 further checks all sensing points stored in it through the Bubble Sort algorithm then finds the sensing point with the maximum pressure.

The conducting module 530 performs the application corresponding to the coordinate of the sensing point with the maximum pressure. In one embodiment, if the sensing point E, corresponding to a media player application, is with maximum pressure comparing with all pressure stored in the access module 520, the conducting module 530 conducts the media player application corresponding to the sensing point E.

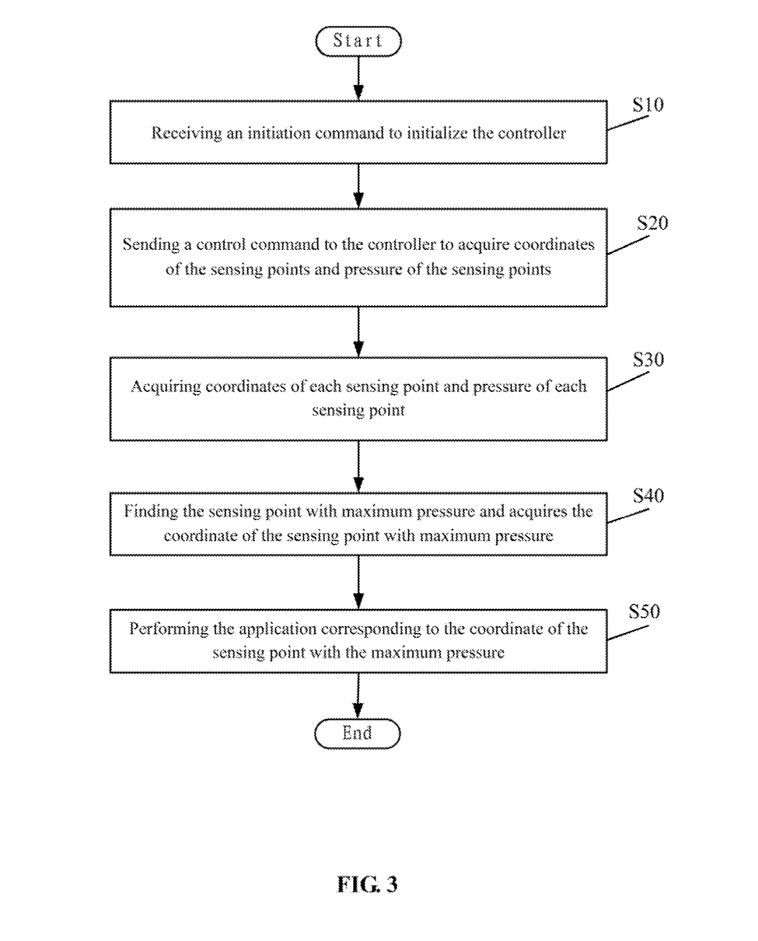

FIG. 3 is a flowchart of a coordinate correction method of the present disclosure. In block S10, the receiver module 500 receives an initiation command generated by the sensor 2 to initialize the controller 4 into a working state when user touches the touch panel 1.

In block S20, the notice module 510 sends a control command to the controller 4, the controller 4 controls the sensor 2 to acquire coordinates of the sensing points touched by user and notices the pressure sensor 3 to acquire pressure of the sensing points.

In block S30, the access module 520 acquires coordinates of each sensing point from the sensor 2 in sequence and acquires pressure of each sensing point from the pressure sensor 3.

In block S40, the access module 520 finds the sensing point with maximum pressure and acquires the coordinate of the sensing point with maximum pressure from the coordinates acquired in S30.

In block S50, the conducting module 540 executes the application corresponding to the coordinate of the sensing point with the maximum pressure.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A touch screen device, comprising:
a touch panel;
a sensor that acquires coordinates of sensing points of the touch screen device when a user touches the touch panel;
a pressure sensor that acquires pressure of the sensing points;
a controller that is initialized when the controller receives an initiation command from the sensor and;
a notice module that sends a control command to the controller, wherein the controller controls the sensor and the pressure sensor to correct coordinates of the sensing points.

2. The touch screen device of claim 1, further comprising:
an access module that finds coordinates of the sensing points with a maximum pressure,
wherein the controller executes an application of the touch screen device corresponding to the coordinates of the sensing point with the maximum pressure.

3. The touch screen device of claim 2, wherein the coordinates of the sensing point with the maximum pressure is found by the Bubble Sort algorithm.

4. The touch screen device of claim 1, wherein the sensor is a touch integrated circuit.

5. A correcting coordinates method of a touch screen device comprising a sensor, a touch panel, and a controller, the method comprising:
receiving an initiation command from the sensor to initialize the controller;
accessing coordinates of sensing points of the touch device and pressures of the sensing points when a touch point is applied to the touch panel;
acquiring the coordinates of the sensing point with the maximum pressure and defining the coordinates of the sensing point having a maximum pressure as an engaged coordinate; and
executing an application of the touch screen device corresponding to the engaged coordinate.

6. The correcting coordinates method of claim 5 further comprising:
accessing coordinates of each of the sensing points and pressures of each of the sensing points in sequence.

7. The correcting coordinates method of claim 5 wherein the step of acquiring the coordinates of the sensing point having the maximum pressure is conducted by the Bubble Sort algorithm.
